(19) United States
(12) Patent Application Publication
(10) Pub. No.: US 2026/0260392 A1
(43) Pub. Date: Sep. 3, 2026

(54) SYSTEM AND METHOD FOR MULTILAYER DESIGN GENERATION GUIDED BY AN ANONYMOUS REGION LAYOUT

(71) Applicant: Microsoft Technology Licensing, LLC, Redmond, WA (US)

(72) Inventors: Danqing HUANG, Mountain View, CA (US); Ji LI, San Jose, CA (US); Zhicong TANG, Beijing (CN); Mingxi CHENG, San Jose, CA (US); Yuhui YUAN, Beijing (CN); Dong CHEN, Beijing (CN); Jianmin BAO, Beijing (CN); Yifan PU, Beijing (CN); Yiming ZHAO, Beijing (CN); Zhanhao LIANG, Foshan (CN)

(73) Assignee: Microsoft Technology Licensing, LLC, Redmond, WA (US)

(21) Appl. No.: 19/068,252

(22) Filed: Mar. 3, 2025

(51) Int. Cl. G06T 11/00; G06N 3/045

(52) U.S. Cl. CPC G06T 11/00; G06N 3/045; G06T 2200/24

(57) ABSTRACT

A data processing system implements receiving a text prompt to create a multilayer graphic design; predicting, by a first generative model based on the text prompt, a layout including anonymous regions each defined by a bounding box without content or region-wise prompt annotations; concurrently generating, by a diffusion transformer, multilayer image latents of a global reference image, a background layer, and transparent foreground layers using a Gaussian noise conditioned on the layout and the text prompt, each of the transparent foreground layers corresponding to one of the anonymous regions; decoding, by a vision transformer, the multilayer image latents into the global reference image, the background layer, and the transparent foreground layers as the multilayer graphic design; composing an output based on the background layer and the transparent foreground layers; providing the output to a client device; and causing a user interface of the client device to display the output.

### BACKGROUND

Artificial intelligence (AI) image generation platforms expand significantly, offering users a variety of tools tailored to diverse creative needs. Although there are diffusion design pipelines that integrate text-to-image technology and improve automatic design creation and variation, these pipelines primarily address visual element variation, and still heavily depend on human-crafted templates for implicit layout guidance. Multilayer transparent image generation is gaining traction, particularly through the use of diffusion models, thereby improving the quality and flexibility of generated images. Methods such as Text2Layer, LayerDiff, and LayerDiffuse support artists and designers to create and manipulate complex images with more control and precision. However, these methods are text-guided at a region/layer level thus only support generating a limited number of transparent foreground layers. Hence, there is a need for fast and easy multilayer transparent image generation that supports unlimited number of transparent foreground layers and is unbound by layer-wise prompts.

### SUMMARY

An example data processing system according to the disclosure includes a processor and a machine-readable medium storing executable instructions. The instructions when executed cause the processor alone or in combination with other processors to perform operations including receiving a text prompt to create a multilayer graphic design; predicting, by a first generative model based on the text prompt, a layout including a plurality of anonymous regions each defined by a bounding box without content or region-wise prompt annotations; concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions; decoding, by a vision transformer, the multilayer image latents into the global reference image, the background layer, and the plurality of transparent foreground layers as the multilayer graphic design; composing an output based on the background layer and the plurality of transparent foreground layers; providing the output to a client device; and causing a user interface of the client device to display the output.

An example method implemented in a data processing system includes receiving a text prompt to create a multilayer graphic design; predicting, by a first generative model based on the text prompt, a layout including a plurality of anonymous regions each defined by a bounding box without content or region-wise prompt annotations; concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions; decoding, by a vision transformer, the multilayer image latents into the global reference image, the background layer, and the plurality of transparent foreground layers as the multilayer graphic design; composing an output based on the background layer and the plurality of transparent foreground layers; providing the output to a client device; and causing a user interface of the client device to display the output.

An example non-transitory computer readable medium data processing system according to the disclosure on which are stored instructions that, when executed, cause a programmable device to perform functions of receiving a text prompt to create a multilayer graphic design; predicting, by a first generative model based on the text prompt, a layout including a plurality of anonymous regions each defined by a bounding box without content or region-wise prompt annotations; concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions; decoding, by a vision transformer, the multilayer image latents into the global reference image, the background layer, and the plurality of transparent foreground layers as the multilayer graphic design; composing an output based on the background layer and the plurality of transparent foreground layers; providing the output to a client device; and causing a user interface of the client device to display the output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for AI-based anonymous-region-layout-guided multilayer design generation are implemented.

FIGS. 2A-2D are diagrams of an AI-based anonymous-region-layout-guided multilayer design generation pipeline of the system of FIG. 1 according to principles described herein.

FIGS. 2E-2G are diagrams of a variation of the AI-based anonymous-region-layout-guided multilayer design generation pipeline of the system of FIG. 1 according to another implementation.

FIGS. 3A-3F are diagrams of example user interfaces of an AI-based anonymous-region-layout-guided multilayer design generation application that implements the techniques described herein.

FIG. 4 is a flow chart of an example process for AI-based anonymous-region-layout-guided multilayer design generation according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for AI-based anonymous-region-layout-guided multilayer design generation generate an anonymous region layout based on a global text prompt, without the limitations of layer wise text prompts. The system and methods directly generate variable multilayer transparent foreground layers based on the anonymous region layout and the global text prompt, and then compose the transparent foreground layers with a background layer into an image using generative models are described herein.

The existing AI-based multilayer transparent image generation systems either simultaneously or iteratively generate image layers. For instance, LayerDiff designs a layer-collaborative diffusion model to generate up to four layers at once under the guidance of both global prompts and layer-wise prompts. Each transparent foreground layer is a foreground layer guided by a global prompt and a specific layer-wise prompt. Although LayerDiff enhances control over image synthesis, allowing for detailed and flexible image composition, LayerDiff involves parsing a global prompt into distinct layer-wise prompts thus limits the number of transparent foreground layers per one composed image. However, users are demanding more layers to independently manipulate individual elements per layer within an image. Each layer can represent distinct components, such as foreground objects, background settings, or intermediate layers, enabling precise adjustments without affecting the entire composition. This layer-based approach facilitates complex editing and composition tasks in graphic design, animation, digital art, and the like.

To address these issues, an AI-based anonymous-region-layout-guided multilayer design generation pipeline is introduced. Such anonymous region layout is obtained by generating bounding boxes annotated with region-specific prompts for each of multiple transparent foreground layers, and then removing the respective region-specific prompt from each bounding box into an anonymous region. In other words, an anonymous region is a bounding box without content or layer-wise prompt annotation. In short, an anonymous region layout is generated by removing the layer-wise prompt annotation from each region of a semantic layout generated by existing methods.

Given a user text request/prompt for a graphic design, instead of generating one pixeled image, the pipeline applies AI to generate an anonymous region layout, generates multiple transparent foreground layers based on the layout, and composes the layers into one graphic design that is editable at the layer level. The anonymous region layout can be provided by the user or predicted by a generative model (e.g., an LLM). The pipeline applies diffusion transformer-based models to jointly generate multiple transparent foreground layers conditioned on the anonymous region layout. The automatically generated intermediate transparent foreground layers as well as the final graphic design, are easily edited by the user and can be scaled up.

These techniques provide a technical solution to the technical problem of lack of fast and easy AI-based multilayer transparent image generation systems and methods. The technical solution automatically generates the anonymous region layout, generates image latents in an embedding space conditioning on the anonymous region layout, and then outputs separate transparent foreground layers and a composed design.

A technical benefit of the approach provided herein is to support generating a variable number of layers at variable resolutions, thereby significantly enhancing scalability. The anonymous region layout can be easily generated in large quantities, thus bypassing the labor-intensive process of manually captioning each region. This not only speeds up the template creation process but also reduces the potential for errors that can occur with manual annotations of regional prompts.

Another technical benefit of this approach is to maintain coherence across different layers. The anonymous region transformer ensures that the generated elements are harmoniously integrated, reducing the semantic gap that often plagues conventional methods. This results in more consistent and visually appealing designs.

Another technical benefit of this approach is to increase computation efficiency. By focusing on one anonymous region within each layer, the pipeline reduces the computational load, enabling the generation of images with numerous distinct layers without compromising on quality. This efficiency is particularly beneficial for applications requiring high-resolution and complex designs, such as graphic design and digital art.

Another technical benefit of this approach is to display the layers to users for interesting applications in graphic design at a layer level, such as element editing, resolution adjustment, element filling, and design variation. The pipeline then regenerates a new output image based on user edits. As such, the pipeline outperforms models specialized in some design subtasks without any task-specific training.

Another technical benefit of the approach provided herein is to significantly improve the user experience in graphic design creation by simply entering a text prompt without selecting any template, to create a graphic design editable per layer.

Another technical benefit of the approach provided herein is to significantly improve the user experience in graphic design creation by supporting layer/image inputs besides a text prompt, to create a graphic design editable per layer.

Yet another technical benefit of this approach is storing the anonymous-region-layout-guided multilayer graphic designs and the respective design layers in the system thereby saving the user significant time and effort in creating similar graphic designs in the future. These and other technical benefits of the techniques disclosed herein will be evident from the discussion of the example implementations that follow.

A “graphic design” refers to a specific style of digital content on a page or displayed on a computer screen. The graphic design can be used in stickers, greeting cards, collages, invitations, publication, email marketing templates, PowerPoint presentations, menus, social media ads, banners and graphics, marketing and advertising, packaging, visual identity, art and illustration graphic design.

The term “style” refers to the distinctive visual characteristics of a digital content item. These characteristics can include color palette, texture (e.g., brushstrokes), composition, layout, structure, scale, typography, level of details and abstraction, whitespace, overall mood, atmosphere, and the like. This definition is more flexible than some defined styles such as minimalist, retro, or modern.

Although various embodiments are described with respect to five layers including a background layer and four transparent foreground layers, it is contemplated that the approach described herein may be used for substantially larger numbers of transparent foreground layers, for greater user control of AI-based design.

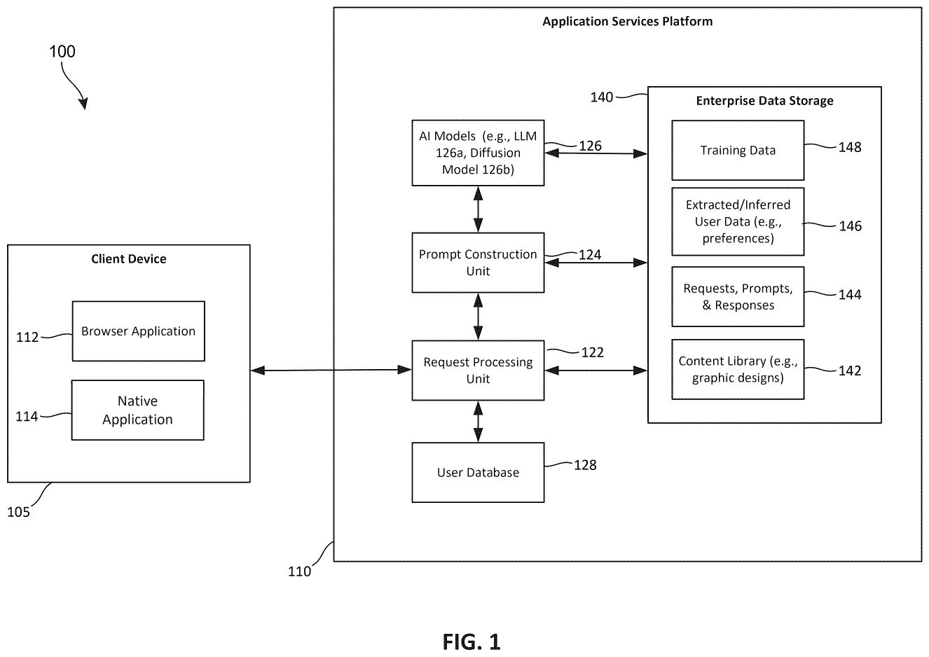

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI-based anonymous-region-layout-guided multilayer design generation applications, presentation applications, website authoring applications, collaboration platforms, communications platforms, and/or other types of applications in which users may create, view, and/or edit various graphic designs based on a text prompt. In the implementation shown in FIG. 1, the application services platform 110 also applies generative AI to easily generate an anonymous-region-layout-guided multilayer graphic design upon user demand according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

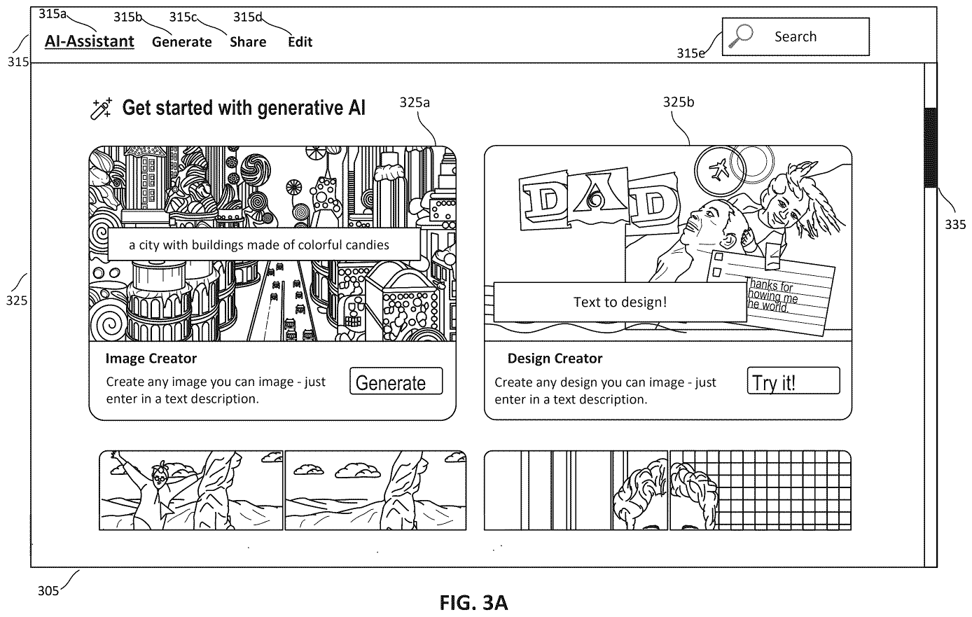

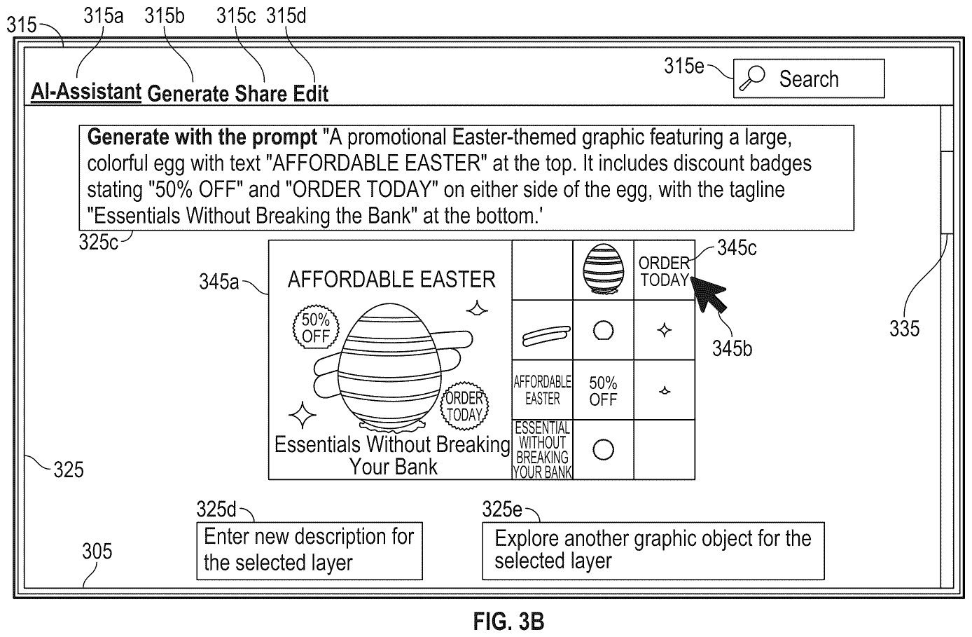

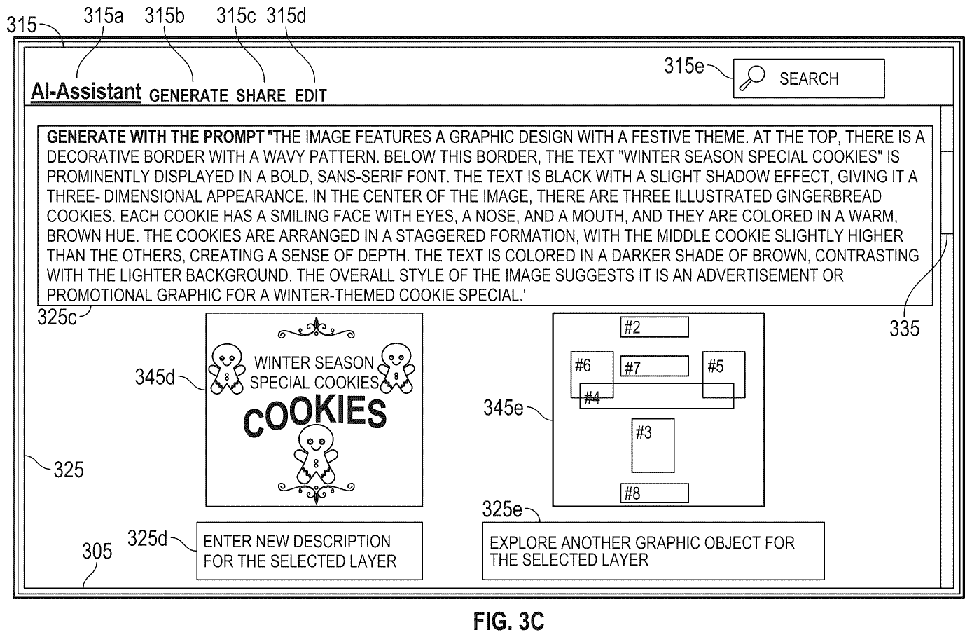

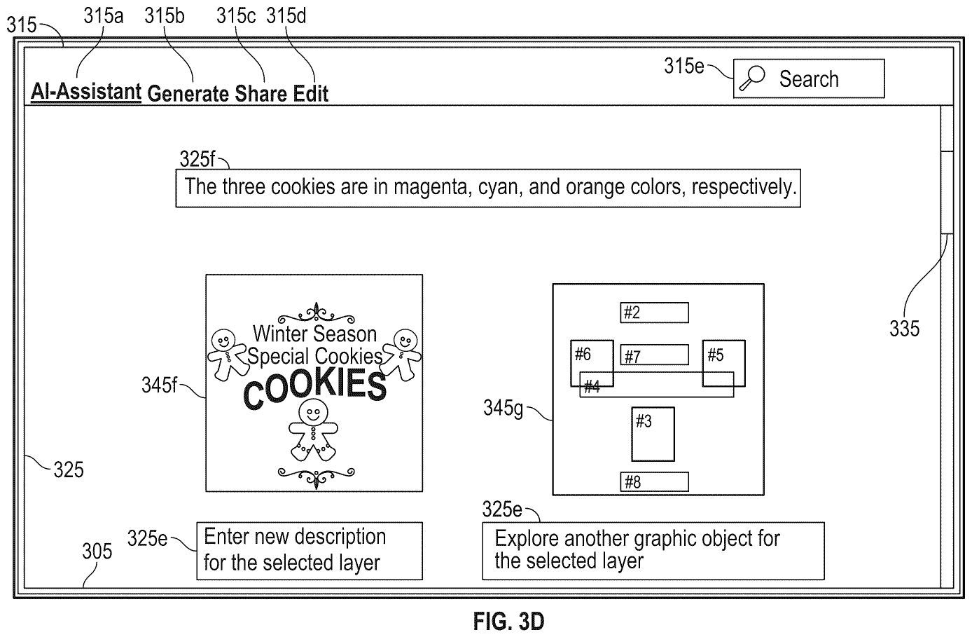

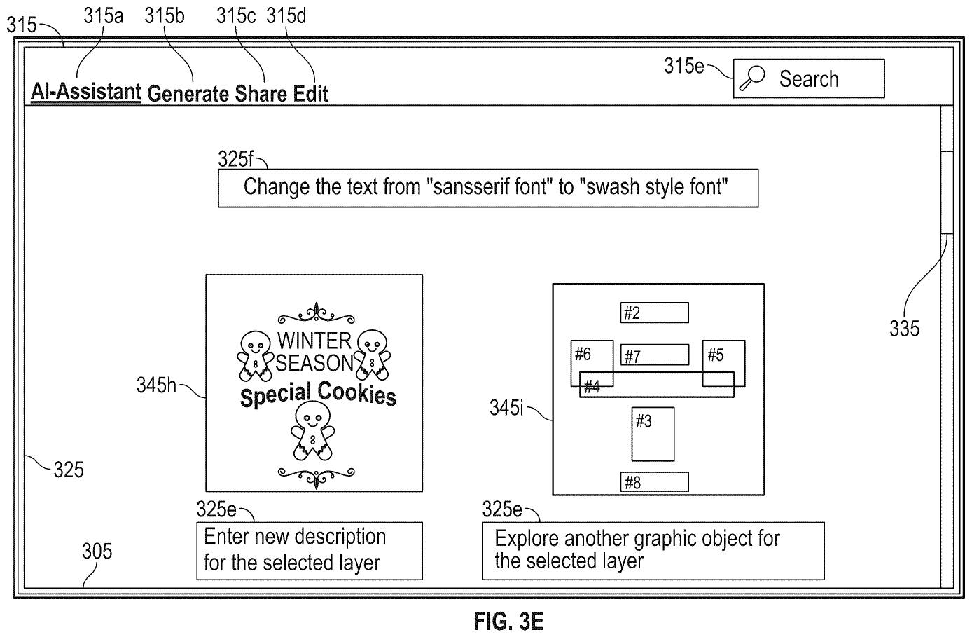

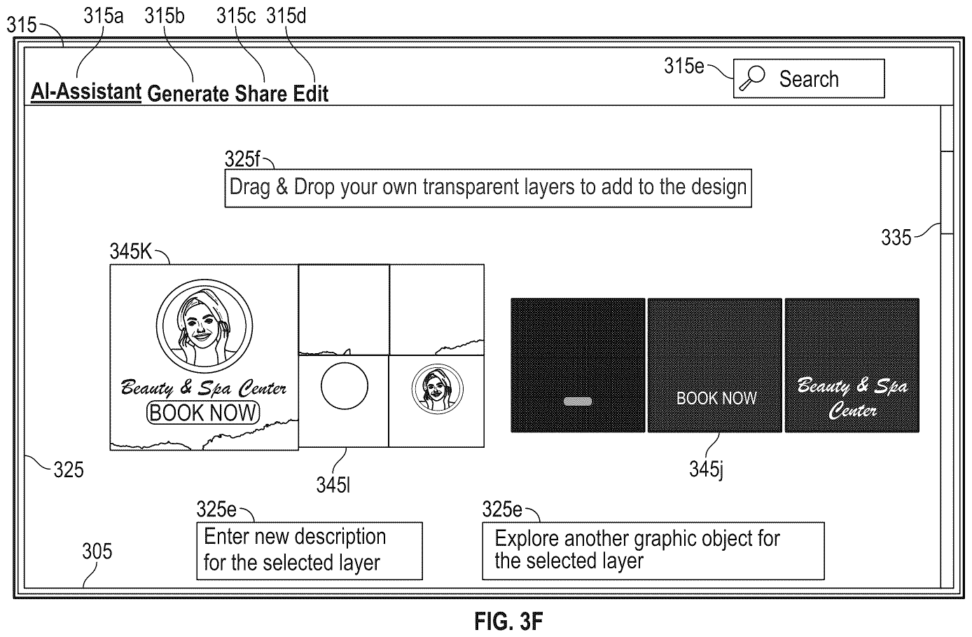

The client device 105 includes a native application 114 and a browser application 112. The native application 114 is a web-enabled native application, in some implementations, which enables an anonymous-region-layout-guided multilayer graphic design based on a text prompt. The web-enabled native application utilizes services provided by the application services platform 110 including but not limited to creating, viewing, and/or editing various graphic designs based on a text prompt. The native application 114 implements a user interface 205 shown in FIGS. 3A-3F in some implementations. In other implementations, the browser application 112 is used for accessing and viewing web-based content provided by the application services platform 110. In such implementations, the application services platform 110 utilizes one or more web applications, such as the browser application 112, that enables users to create, view, and/or edit various graphic designs based on a text prompt for an online application. The browser application 112 implements the user interface 205 shown in FIGS. 3A-3F in some implementations. The application services platform 110 supports both the native application 114 and the browser application 112 in some implementations, and the users may choose which approach best suits their needs.

The application services platform 110 includes a request processing unit 122, a prompt construction unit 124, AI model(s) 126, a user database 128, and an enterprise data storage 140 that includes a visual content library 142, requests, prompts, and responses 144, extracted/inferred user data 146 (e.g., user preferences), training data 148, and the like. The request processing unit 122 is configured to receive requests from the native application 114 and/or the browser application 112 of the client device 105. The requests may include, but are not limited to, requests to create, view, and/or edit various graphic designs based on a text prompt according to the techniques provided herein.

The prompt construction unit 124 is responsible for creating and refining prompts to interact effectively with the AI model(s) 126. This involves designing input instructions that guide the AI model(s) 126 to produce accurate and contextually relevant outputs. The key tasks of the prompt construction unit 124 in the AI-based anonymous-region-layout-guided multilayer design generation pipeline include constructing prompts to AI model(s) 126 (e.g., the LLM 126a) to generate an anonymous region layout, generate multiple transparent foreground layers based on the layout, and compose the layers into one graphic design that is editable at the layer level. The prompt construction unit 124 also prompts diffusion transformer-based models to jointly generate multiple transparent foreground layers conditioned on the anonymous region layout, then compose an graphic design editable at a layer level.

In some implementations, the pipeline provides a feedback loop by augmenting thumbs up and thumbs down buttons for each multilayer transparent graphic design output in the user interface 305. If the user dislikes a multilayer transparent graphic design output, the application can ask why and use the user feedback data to improve the AI model(s) 126. A thumbs down click could also prompt the user to indicate whether the multilayer transparent graphic design output was too bright, too dark, too big, too small, or was assigned the wrong style/object, or the like. In other implementations, the application can retrieve user graphic design preferences data from the user database 128, and adjusts the rejected multilayer transparent graphic design output based on the user graphic design preferences data. The user database 128 can be implemented on the application services platform 110 in some implementations. In other implementations, at least a portion of the user database 128 are implemented on an external server that is accessible by the prompt construction unit 124.

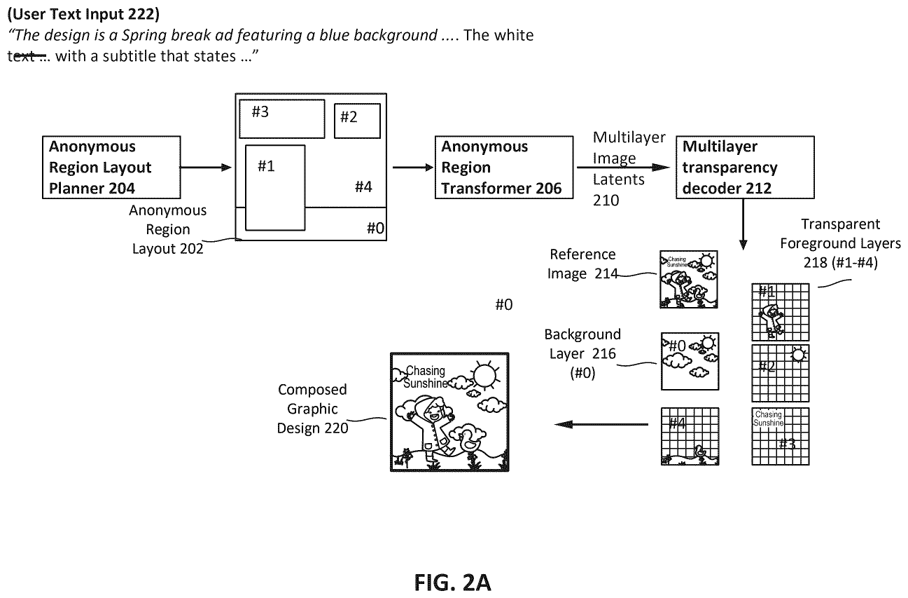

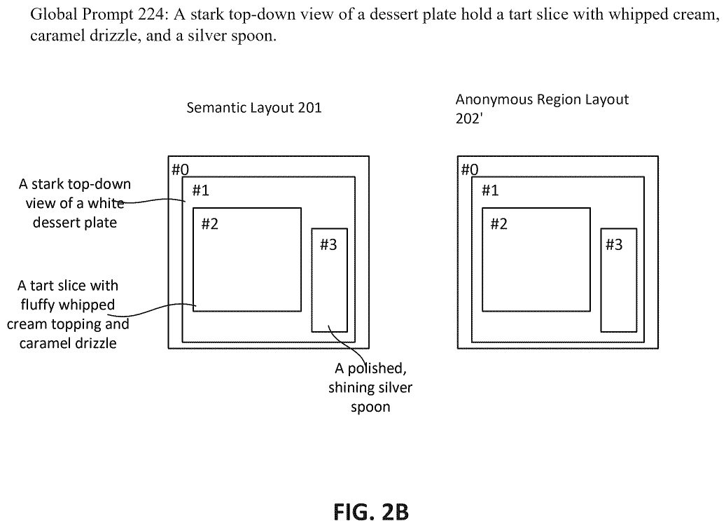

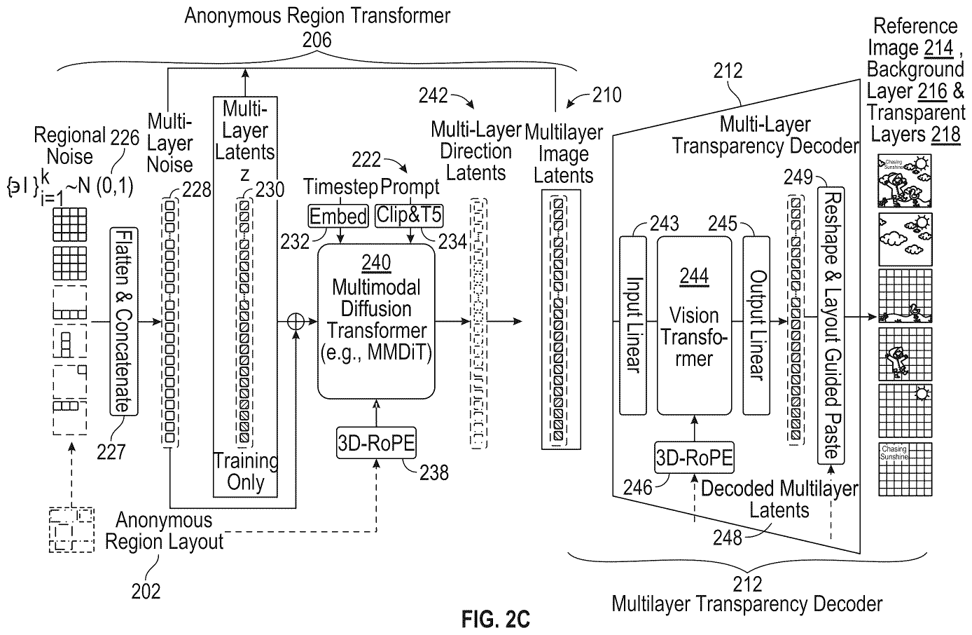

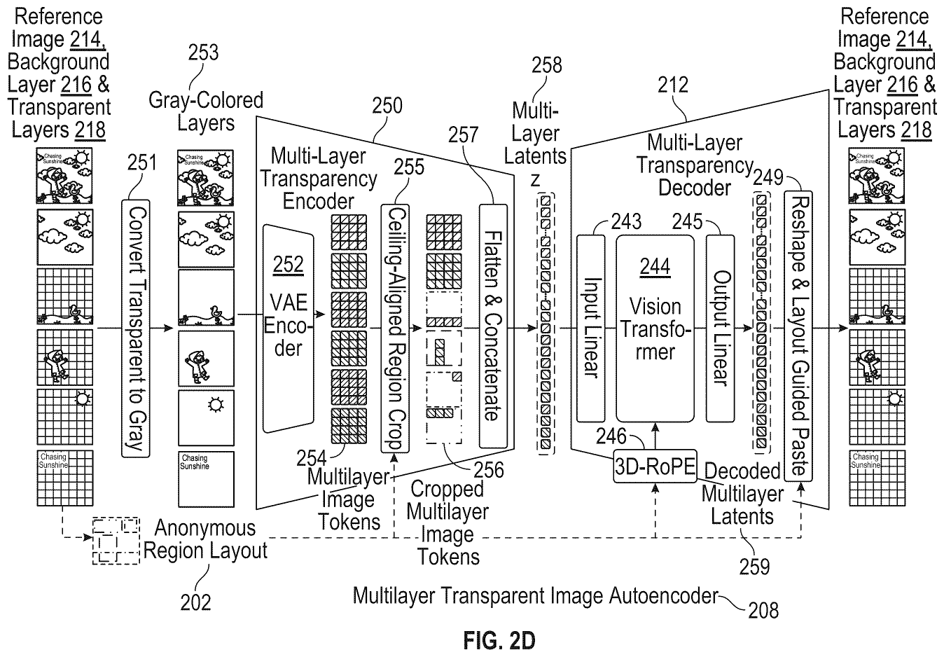

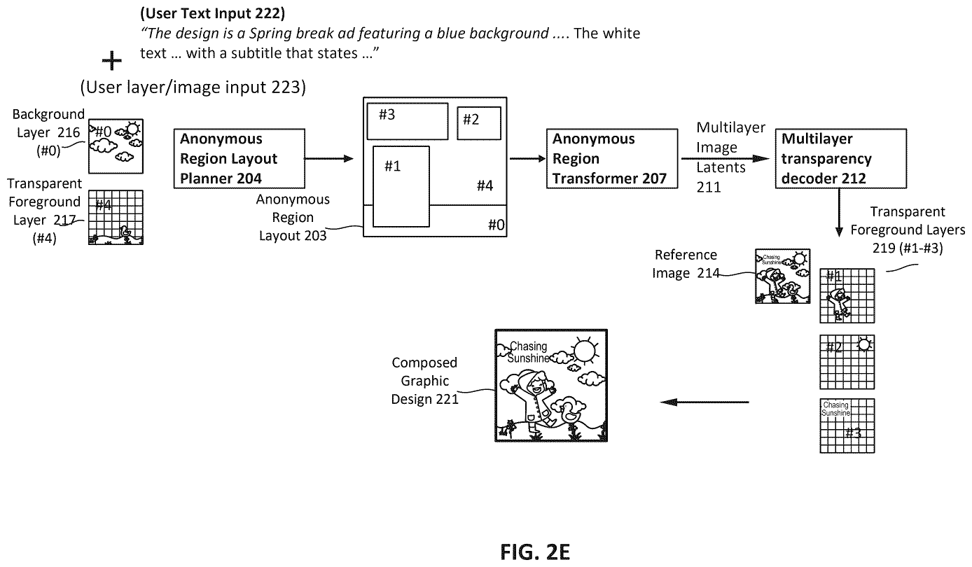

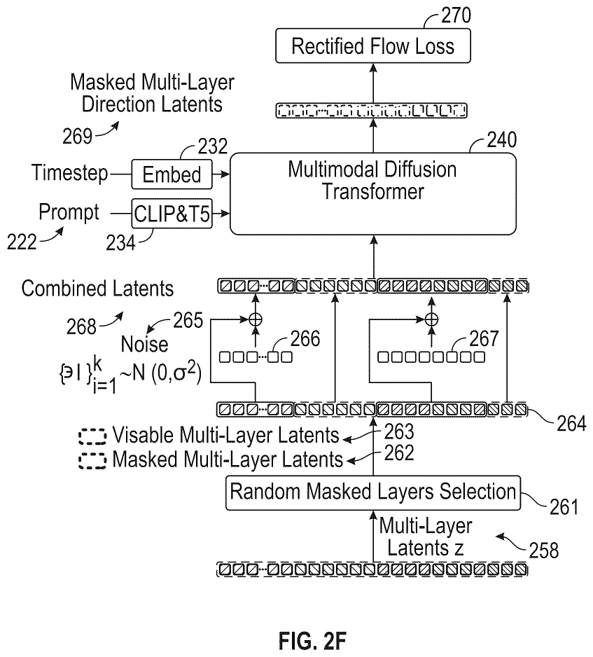

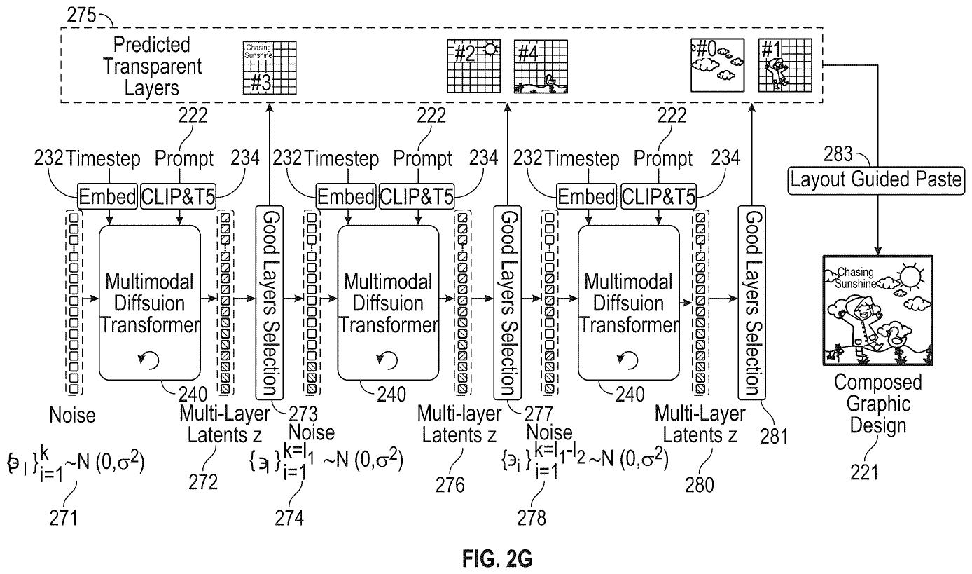

FIGS. 2A-2D are conceptual diagrams of an AI-based anonymous-region-layout-guided multilayer design generation pipeline of the system of FIG. 1 according to principles described herein. As mentioned, the pipeline enables diffusion transformer-based models to jointly generate images with multiple transparent foreground layers conditioned on an anonymous region layout 202 provided by the user or predicted by a LLM (e.g., a LLM 126a). The pipeline includes three key components: an anonymous region layout planner 204 for planning the anonymous region layout 202, an anonymous region transformer 206 for generating image latents 210 in an embedding space conditioned on the anonymous region layout 202, and a multilayer transparent autoencoder 208 that includes a multilayer transparency decoder 212 for outputting a reference image 214, a background layer 216, and separate transparent foreground layers 218. The user can later select to compose a composed graphic design 220 based on the background layer 216 and the transparent foreground layers 218. In FIG. 2A, given a user text input 222 of ‘the image is a vibrant Spring break ad featuring a rich blue background with art-inspired designs. The white text in the center announces a ‘special offer Spring break big sale’, with a subtitle that states ‘Discount up to 30% off’”, the anonymous region layout planner 204 predicts the anonymous region layout 202. Table 1 lists an example output (e.g., the anonymous region layout 202) of the anonymous region layout planner 204. The anonymous region layout 202 includes a background box (i.e., layer 0) and transparent foreground layer anonymous bounding boxes #1-#4 (layers 1-4) in FIG. 2A given the user text input 222.

TABLE 1

Output: [{ “layer”: 0, “x”: 512, “y”: 512, “width”:
1024, “height”: 1024 }, { “layer”: 1, “x”:
744, “y”: 496, “width”: 496, “height”: 256 },
{ “layer”: 2, “x”: 856, “y”: 704, “width”: 240,
“height”: 96 }, { “layer”: 3, “x”: 792, “y”:
640, “width”: 368, “height”: 64 }, { “layer”: 4,
“x”: 840, “y”: 336, “width”: 272, “height”: 64 }]

FIG. 2B depicts how an anonymous region layout is different from a semantic layout. In this case, the user input a global prompt 224: “A stark top-down view of a dessert plate hold a tart slice with whipped cream, caramel drizzle, and a silver spoon.” A semantic layout 201 requires specifying what objects to generate in each given bounding box/layer in a layer-wise prompt. For example, the #1 box is specified with text tokens: a stark top-down view of a white dessert plate, the #2 box is specified with text tokens: a tart slice with fluffy whipped cream topping and caramel drizzle, and the #3 box is specified with text tokens: a polished, shining silver spoon. On the other hand, an anonymous region layout 202′ offers greater flexibility by only identifying where the bounding boxes are, without any content of text tokens. As later discussed, the pipeline leverages the prior knowledge, activated by the global prompt 224, to intuitively infer the semantic label of each anonymous region, and learn to harness this capability to autonomously determine what to generate in each box.

In the context of diffusion models, a token represents the fundamental units of data, such as words or sub-words for text, a pixel for an image, which are transformed into embeddings for model processing. An embedding provides a continuous vector representation of discrete tokens, enabling the application of continuous processes in the diffusion models. A latent serves as a compressed representation capturing the essence of the data, facilitating efficient processing in the diffusion models.

Experiments show that the visual tokens of each the existing models primarily attend to the layer-wise prompts while relying less on the predicted reference image, which results in less coherent outputs. The essential reasons behind the conflict between the global reference image and the layer-wise prompts appears to stem from the disparity between the layer-wise prompts and the global prompts, as there exists a non-trivial gap between the global prompt and the layer-wise prompt associated with the same regional crop. On the other hand, without the burden of the layer-wise prompts, the pipeline predicts the global reference image with coherence across different layers.

The anonymous region layout planner 204 is implemented by fine-tuning an LLM (e.g., LLaMa-3.1-8B) based on layout dataset. The anonymous region layout planner 204 not only achieves a better alignment between generated images and the real images, but also operates more than three times faster than a semantic layout planner. Removing the region-specific prompts from a semantic layout to provide an anonymous region layout can enhance overall performance by avoiding conflicts among region-wise prompts, especially regarding layer coherence, as reflected by the higher peak signal-to-noise ratio (PSNR) scores.

Then the anonymous region transformer 206 generates the image latents 210 in an embedding space conditioned on the anonymous region layout 202 in FIG. 2A. The multilayer transparency decoder 212 concurrently generates a global reference image 214, a background layer 216, and four transparent foreground layers 218 from the image latents 210. Incorporating layout guidance into the generation process involves introducing noisy tokens that represent spatial information of the anonymous region layout 202, such as coordinates and sizes of the anonymous bounding boxes. These tokens guide a diffusion model of the anonymous region transformer 206 to place design elements within the layers.

Several types of latents play crucial roles in the functionality and performance of the diffusion models. Noisy latents serve as intermediate representations during the diffusion process, capturing progressively noisier versions of the data. Positional latents encode spatial or sequential information, ensuring the model maintains the inherent structure of the data. Text latents provide a mechanism for conditioning the model on textual information, guiding the generation process to produce outputs aligned with textual descriptions. Timestep latents represent the state of the data at specific points in the diffusion process, facilitating the diffusion model's learning of the noise-to-data trajectory. Discrete latents capture specific, often categorical, attributes of the data, simplifying the modeling of complex distributions. Semantic latent directions allow for controlled manipulation of the generated data along meaningful dimensions, enabling targeted edits and modifications. Image latents encode the full image representation. Direction latents define how an image can change along semantic axes.

The global reference image 214 is used to leverage the original capabilities of the existing text-to-image generation model, and to ensure overall visual harmonization by preventing conflicts and inconsistency across layers. Generating all layers simultaneously also avoids the need for inpainting algorithms to complete missing parts of the occluded layers.

FIG. 2C depicts how the anonymous region transformer 206 works in conjunction with the multilayer transparency decoder 212 to perform denoising diffusion on noisy multilayer latents then convert de-noised multilayer latents into a pixel space as transparent layers and images. The pipeline converts a single image generation model into a multilayer generation model by modifying the input tokens as multilayered. For example, the anonymous region transformer 206 processes a multilayer layout-guided noise into the multilayer image latents 210.

For instance, the anonymous region transformer 206 inputs a regional noise 226, timestep embeddings 232, text embeddings 234, and RoPE positional embeddings 238 into a multimodal diffusion transformer (e.g., MMDiT 240) to generate the multilayer image latents 210. The MMDiT 240 is the heart of the anonymous region transformer 206 and is trained in the multilayer transparent autoencoder 208 in FIG. 2D to generate the multilayer image latents 210 from pure noise. The multilayer transparency decoder 212 inputs the multilayer image latents 210 via an input linear layer 243, a vision transformers (ViT) 244, and an output linear layer 245 to convert the multilayer image latents 210 into a pixel space as the reference image 214, the background layer 216, and the transparent foreground layers 218.

Diffusion models, such as MMDiT 240, are generative models that learn to reverse a gradual noising process applied to data, effectively modeling complex data distributions. Vision Transformers, such as ViT 244, on the other hand, treat images as sequences of patches, enabling the modeling of global relationships within the data. By combining these approaches in such manner, the pipeline leverages the strengths of both methodologies for improved multilayer image generation.

In one implementation, the pipeline applies FLUX.1[dev], as the MMDiT 240. FLUX.1 [dev] is an open-source AI model that generates images from text descriptions, and is designed for non-commercial use. The MMDiT 240 uses different sets of model weights to process text tokens and image tokens thereby effectively integrating textual and visual information to generate images that are semantically aligned with textual descriptions and, when available, conditioned on visual cues. In addition, the MMDiT 240 considers timestep embeddings and positional embeddings as discussed in detail later.

The core of MMDiT 240 is a diffusion process, where images are generated by progressively denoising a random noise input. This iterative approach allows the MMDiT 240 to construct image latents from abstract representations to detailed visuals. The process begins with a noise vector (e.g., layout-guided noisy tokens conditioned on an anonymous region layout L), which is gradually refined over multiple steps to produce a final image that aligns with a global prompt T. This technique ensures that the generated images are not only visually appealing but also semantically consistent with the global prompt T.

In FIG. 2C, the anonymous region transformer 206 receives an anonymous region layout L (e.g., the anonymous region layout 202) and the global prompt T (e.g., the user text input 222) as input. The anonymous region layout L is used to compute the regional noise 226

$$( e . g . , {\{ {ϵ}_{i} \}}_{i = 1}^{K} ∼ 𝒩 ( 0 , 1 ) ) ,$$

by adding Gaussian noise to a sequence of clean multilayer latents that encodes the bounding boxes of the anonymous region layout L. To learn the reverse distribution q(xt−1|xt), the anonymous region transformer 206 samples xT from N(0,I), runs the reverse diffusion process and acquires a sample from q(x0), thereby generating a novel data point from the original data distribution. The multilayer noise 228 thus includes positional tokens/embeddings encoded from the anonymous region layout L that provide information about the position of each token within the sequence. The regional noise 226 is then flattened and concentrated via a step 227 into a multilayer noise 228 (including layout-guided noisy tokens). The MMDiT 240 then generates multilayer direction latents 242 from the multilayer noise 228, the timestep embeddings 232, the text embeddings 234, and the RoPE positional embeddings 238.

This layout positional context is crucial for the MMDiT 240 to understand the structure and positions of the bounding boxes of the anonymous region layout 202 (regardless of the structure and order of the text elements the global prompt T), which in turn influences the spatial arrangement and composition of the generated image. By integrating the layout positional embeddings, the MMDiT 240 can maintain coherence and accurately reflect the relationships contained in the anonymous region layout 202.

The timestep embeddings 232 are a specific form of positional embeddings that provide temporal context (e.g., a particular timestep) during the denoising process. MMDiT 240 combines the timestep embeddings 232 with the text embeddings 234 (as text conditioning inputs) to modulate the generation process effectively. This integration of the timestep embeddings and layout positional context into the modulation mechanism enables conditional generation that allows MMDiT 240 to produce images that are coherent and aligned with the global prompt T. To guide the image generation process, MMDiT 240 further utilizes textual embeddings derived from the global prompt T. These embeddings capture the semantic essence of the text to influence the denoising steps. By conditioning the diffusion process on these textual embeddings, MMDiT 240 ensures that the generated image latents accurately reflect the described content. This conditioning mechanism allows for precise control over the image generation, enabling the creation of images that closely match the textual descriptions. In one implementation, the anonymous region transformer 206 leverages multiple text encoders (e.g., CLIP (contrastive language-image pretraining) and T5 models) to capture diverse aspects of the global prompt T, by tokenizing and embedding text data in the global prompt T into the text embeddings 234 a continuous vector space. The text embeddings 234 capture the semantic nuances of the global prompt T, providing the MMDiT 240 with detailed descriptions to guide image generation.

The T5 model is utilized to process the global prompt T (e.g., the user text input 222), providing a comprehensive understanding of the language, which aids in generating images that accurately reflect the nuances of the prompts. The CLIP model is employed to encode text representations, capturing semantic information that aligns textual and visual modalities. Utilizing multiple text encoders allows the model to grasp complex and nuanced prompts, leading to more accurate image generation.

Regarding the RoPE positional embeddings 238, the anonymous region layout L (e.g., the anonymous region layout 202) is also encoded via 3D RoPE in the RoPE positional embeddings 238. Typically, each element in the input is represented as a “query” which is compared to other elements (the “keys”) to calculate an “attention score” representing how much the model should focus on that specific element; these scores are then used to weigh the “value” of each element, creating a context-aware representation. Rotary Position Embedding (RoPE) is a specific type of position embedding that applies a rotation operation to key and query in self-attention layers as channel-wise multiplications, which allows models to capture relative positional information of the anonymous region layout L more effectively. As such, the accurate relative position information is encoded for all noisy tokens, which is then utilized in decoding by the multilayer transparency decoder 212. In addition, RoPE allows MMDiT 240 to handle sequences of varying lengths, making the MMDiT 240 more flexible and efficient.

The anonymous region transformer 206 first extracts the layer-wise 3D indexing for a given noisy latents (e.g., the multilayer noise 228) according to the anonymous region layout 202, i.e., pn={px n, py n, pl n} represent the width index, height index, and layer index of the n-th latents, respectively. Then, n-th query and m-th key represent as qn and km E Rdhead, respectively, and the anonymous region transformer 206 splits both query and key into three parts along channel dimensions, i.e., qn={qx n, qy n, ql n} and km={kx m, ky m, kl m}. Thus, the (n, m) component of the attention matrix is calculated as formula (1).

$${A}_{( n , m )} = {\sum }_{c ∈ \{ x , y , l \}} Re [ {q}_{n}^{c} ( {k}_{m}^{c} ) * {e}^{i ( {p}_{n}^{c} - {p}_{m}^{c} ) θ} ] \qquad ( 1 )$$

where Re[⋅] is the real part of a complex number and

$${( {k}_{m}^{c} )}^{*}$$

represents the conjugate complex number of

$${k}_{m}^{c} .$$

θ∈R preset non-zero constant.

The 3D RoPE applied in conjunction with the pre-trained ViT 244 has a distinctive feature. Unlike previous RoPE methods that compute solely on the entire image, the pipeline incorporates a layout, i.e., layout-conditional 3D RoPE. Given the anonymous region layout 202, 3D RoPE embedding 246 are calculated. Its physical significance and distance metrics are derived from the ViT 244, trained on large datasets like ImageNet. The input dimension of the ViT 244 is fixed, e.g., 384. However, the output dimension of the multilayer latents is over 1500. To align these dimensions, the output from the ViT 244, which has a higher dimensionality, is adjusted. After alignment, the dimension becomes 384. Since RGBA images have four channels, it's necessary to convert the 384 dimensions into four channels. Additionally, there's a resolution alignment issue: the ViT processes images at ⅛th resolution, so operations like channel-to-spatial mapping are performed to achieve this alignment. In ViTs, the channel-to-spatial mapping involves mechanisms that integrate information across both channel and spatial dimensions to enhance feature representation. The spatial dimension refers to the two-dimensional grid of pixels (height and width), while the channel dimension pertains to the different feature maps or color channels (e.g., RGB) at each spatial location.

In addition to above-discussed embeddings, MMDiT 240 employs internal visual embeddings to enhance the coherence and quality of the generated images. These visual embeddings serve as intermediate representations that guide MMDiT 240 during the denoising process. By leveraging both textual and visual embeddings, MMDiT 240 can effectively capture complex relationships between text and image, resulting in more accurate and contextually relevant outputs. The MMDiT 240 leverages the integration of the above-discussed embeddings to generate multilayer direction latents 242.

The generation of image latents involves a process where the MMDiT 240 predicts the latent direction multiple times. The latent direction represents relationship(s) such as analogies or transformation(s). This iterative process, often referred to as sampling, requires the MMDiT 240 to perform numerous iterations—commonly 28 or 50 steps. After completing these iterations, the output of the MMDiT 240 (e.g., the multilayer image latents 210) is passed through the linear input layer 243 to the ViT 244. The ViT 244 decodes the multilayer image latents 210 into decoded multilayer latents 248 in a pixel space. The decoded multilayer latents 248 then go via a step 249 of reshaping and layout-guided pasting to provide the global reference image 214, the background layer 216, and the four RGBA transparent foreground layers 218 in FIG. 2C.

Initially, the MMDiT 240 predicts a direction and uses this direction to compute Xt−1X_{t−1}Xt−1. For example, starting with XTX_TXT, which is pure noise, the MMDiT 240 denoises it step by step. To predict X49X_{49}X49, the MMDiT 240 employs a formula based on the current predicted noise to calculate X49X_{49}X49. After predicting X49X_{49}X49, the MMDiT 240 uses X49X_{49}X49 to predict the next step.

During training, the input to the MMDiT 240 is multilayer latents z 230 generated from the original image signal with varying levels of added noise. In this example, the original image consist of multiple layers: the entire image, a background layer, and four foreground layers. During the training process, the MMDiT 240 generates images, starting from noise and progressively refining the image through iterative denoising steps. Each step involves predicting the noise present and subtracting it to move closer to the desired image. The MMDiT 240 learns to reverse the diffusion process, transforming random noise into coherent images through these successive iterations.

In the inference phase, the MMDiT 240 predicts the entire image, the background layer, and all foreground layers, allowing them to move continuously in the direction field. The MMDiT 240 iteratively processes from X50X_{50}X50 to X49X_{49}X49, X48X_{48}X48 and so on. The MMDiT 240 predicts the direction from X49X_{49}X49 to X48X_{48}X48 and with a specific formula, calculates the previous latent state. The multilayer direction latents 242 guides the generation process along specific semantic directions, enabling the MMDiT 240 to produce variations of data that adhere to certain attributes or transformations. In other words, the multilayer direction latents 242 function like velocity vectors, guiding the MMDiT 240 from one point to another. At each step, the MMDiT 240 predicts the speed in a high-dimensional space, moves to the next position, and continues this process iteratively. Starting from pure noise, the MMDiT 240 predicts a direction, moves accordingly, and repeats this until reaching the final position.

Referring back to the ViT 244, it is in the multilayer transparency decoder 212 of the trained multilayer transparent autoencoder 208. As mentioned, the ViT 244 has the input liner layer that coverts the multilayer image latents 210 received from the anonymous region transformer 206 into a format required by the ViT 244. In one implementation, The ViT 244 has a configuration including twelve layers, a hidden dimension size of 768, an MLP dimension size of 3072, and 12 attention heads.

The multilayer multimodal transformer-based architecture in FIG. 2C facilitates scalability, enabling the MMDiT 240 to handle higher resolutions and more complex generation tasks. Through a combination of language modeling and diffusion processes, the pipeline achieves a harmonious blend of textual and position data (i.e., layout-guided noise), leading to advanced text-to-image generation.

As mentioned, the multilayer transparent autoencoder 208 in FIG. 2D is structured to train the multilayer transparency decoder 212 to output a reference image, a background layer, and four transparent foreground layers from a pure noise. In addition to the multilayer transparency decoder 212, the multilayer transparent autoencoder 208 has the multilayer transparency encoder 250. The multilayer transparency encoder 250 include a VAE encoder 252. During the training, the output of the multilayer transparent autoencoder 208 is expected to be as close to input training data, such as the global reference image 214, the background layer 216, and the four transparent foreground layers 218, preferably identical.

This setup of the ViT 244 within the multilayer transparency decoder 212 allows the ViT 244 to process images as sequences of patches. Using training data that include both textual descriptions (e.g., text embeddings from the global prompt T), associated spatial information (e.g., anonymous region layout data), and layer information, allowing the multilayer transparency decoder 212 to learn how to incorporate layout constraints during image generation. For example, the layer information includes visual embeddings of the global reference image 214, the background layer 216, and the four RGBA transparent foreground layers 218. These features are then embedded into a similar vector space, allowing the multilayer transparency decoder 212 to understand and incorporate visual information during the generation process. This approach ensures that the multilayer transparency decoder 212 generates images adhere to specified anonymous region layouts, thereby enhancing the coherence and relevance of the output concerning the input text prompts.

Although the multilayer transparency decoder 212 only needs to decode the transparency for all the foreground transparent foreground layers to generate a composed image, the multilayer transparency encoder 250 sends both the entire image and the background layer as additional conditions, along with applying supervision on them, that leads to even better performance. The multilayer transparent autoencoder 208 hypothesizes that the information from the entire and background layers is beneficial for the transparency layers to interact more effectively, thereby ensuring a more coherent final composed image with these transparent foreground layers.

The training data for the multilayer transparent autoencoder 208 includes a plurality of multilayer transparent images (e.g., the global reference image 214, the background layer 216, and the four RGBA transparent foreground layers 218). For example, each training image consists of an RGB background layer Ibg ∈R×W×3, and a variable number K of RGBA foreground layers, {Iifg∈RHi×Wi×4}Ki=1. The corresponding merged image Img ∈RH×W×3 can be obtained by integrating Ibg as the base layer and overlaying all Iifg layers according to a predefined layout. L={xic, yic, Hi, Wi}Ki=1 represents an anonymous region layout of all K foreground layers. Here, xic, yic and Hi, Wi denote the center coordinates, and the height and width of the bounding box that encapsulates the i-th transparent foreground layer. The anonymous region layout L is inherently encoded in the alpha channel of each foreground layer. Thus, {xic, yic, Hi, Wi}can be obtained by computing the bounding box of the non-transparent (or opaque) region from the alpha channel of Iifg.

The multilayer transparency encoder 250 integrates the transparency in alpha channel Iifg,α directly into the RGB channels Iifg,RGB. Specifically, the multilayer transparency encoder 250 computes \hat{ }Iifg=(0.5Iifg,α+0.5)×Iifg,RGB, thereby converting the transparent-background layer Iifg into a gray-background layer \hat{ }Iifg via a step 251. All channel values are normalized to range between −1 to 1. This gray background is sufficient to ensure accurate transparency decoding in subsequent stages.

The multilayer transparency encoder 250 concatenates the merged reference image Img, the background layer Ibg, and all the padded gray-background layer layers {\hat{ }Iifg}Ki=1 along the batch dimension into gray-colored layer 253, and then feeds the gray-colored layer 253 into the VAE encoder 252. The VAE encoder 252 down-samples the spatial dimension with a factor of eight while obtaining a 16-channel feature dimension. The extracted image tokens (as of the first two blocks of multilayer image tokens 254) of the merged reference image Img and the background layer Ibg are skipped step 255 and directly flattened in step 257 into a sequence of image latents (as a part of multilayer image latents z 258) based on formula (2).

$${z}_{mg} = Flatten ( {ε}_{VAE} ( {I}_{mg} ) ) , {z}_{bg} = Flatten ( {ε}_{VAE} ( {I}_{bg} ) ) \qquad ( 2 )$$

The image tokens of the foreground image layers (as the remaining multilayer image tokens 254) are first subjected to a ceiling-aligned tight crop in step 255 into cropped multilayer image tokens 256 and then flattened into image latents (as the remaining multilayer image latents z 258) with different lengths in step 257 using formula (3). The ceiling-aligned tight crop step 255 removes most transparent pixels from the remaining four blocks of the multilayer image tokens 254 to compel the ViT 244 to focus on the smallest rectangle encapsulating the non-transparent foreground region, i.e., a regional full attention scheme.

$${z}_{fg}^{i} = Flatten ( Crop ( {ε}_{VAE} ( {\hat{I}}_{fg}^{i} ) , {L}_{i} ) ) , i = 1 , … , K \qquad ( 3 )$$

where Lᵢ denotes the foreground area position of layer

$${I}_{fg}^{i} .$$

In other words, the ceiling-aligned tight crop step 255 is performed by identifying the tightest bounding box with a height and width divisible by 16 to adapt to the VAE encoder 252 down-sample rate of 8 and the MMDiT 240 patch size of 2. The regional full attention scheme improves efficiency and explicitly constrains layer predictions to align with the positions specified by the anonymous region layout 202. Finally, the compressed multilayer image latent z 258 is obtained by concatenating the latents of the reference image, the background layer, and the transparent foreground layers based on formula (4).

$$z = Concatenate ( {z}_{mg} , {z}_{bg} , {z}_{fg}^{1} , {z}_{fg}^{2} , … , {z}_{fg}^{K} ) \qquad ( 4 )$$

Referring back to the multilayer transparency decoder 212, the setup of the ViT 244 within the multilayer transparency decoder 212 allows the ViT 244 to process images as sequences of patches. Using training data that include both textual descriptions (e.g., text embeddings from the global prompt T), associated spatial information (e.g., anonymous region layout data), and layer information, allowing the multilayer transparency decoder 212 to learn how to incorporate layout constraints during image generation. For example, the layer information includes visual embeddings of the global reference image 214, the background layer 216, and the four RGBA transparent foreground layers 218. These features are then embedded into a similar vector space, allowing the multilayer transparency decoder 212 to understand and incorporate visual information during the generation process. This approach ensures that the multilayer transparency decoder 212 generates images adhere to specified anonymous region layouts, thereby enhancing the coherence and relevance of the output concerning the input text prompts.

Although the multilayer transparency decoder 212 only needs to decode the transparency for all the foreground transparent foreground layers to generate a composed image, the multilayer transparency encoder 250 sends both the entire image and the background layer as additional conditions, along with applying supervision on them, that leads to even better performance. The multilayer transparent autoencoder 208 hypothesizes that the information from the entire and background layers is beneficial for the transparency layers to interact more effectively, thereby ensuring a more coherent final composed image with these transparent foreground layers.

As mentioned, the multilayer transparency decoder 212 is based on a standard ViT architecture (including the ViT 244, the input linear layer 243 and the output linear layer 245). The ViT 244 is trained to support direct decoding of a variable number of transparent foreground layers at varying resolutions from a sequence of concatenated visual latents in a single forward pass. The input linear layer 243 coverts the multilayer image latents 210 received from the anonymous region transformer 206 into a format required by the ViT 244. The output linear layer 245 reshape an output of the ViT 244 to form an RGBA patch. In one implementation, the mathematical formulations are shown as formulas (5)-(6).

$$v = ViT ( {Linear}_{in} ( z ) ) \qquad ( 5 )$$

$$t = Reshape ( {Linear}_{out} ( v ) , L ) \qquad ( 6 )$$

where ViT(⋅) represents the ViT model, Linearin(⋅) denotes a linear projection that transforms the channel dimension of the latent representation, i.e., 16, to the hidden dimension size of the ViT 244, especially 768, v represents the output representation of the ViT 244, Linearout(⋅) denotes a linear projection that transforms the output dimension from 768 to 256, where each token can be reshaped to form an RGBA patch of size 8×8×4. The multilayer transparency decoder 212 processes the multilayer image latents z 258 into decoded multilayer latents 259 (i.e., image tokens) in the pixel space. The multilayer transparency decoder 212 reshapes each token to form an RGBA patch of size 8×8×4, then outputs a reference image, a background layer, and four transparent foreground layers.

Another key design of the anonymous-region-layout-guided multilayer design generation pipeline is the replacement of the original absolute position embedding with 3D RoPE as discussed above. Encoding positional information is essential for the MMDiT 240 to distinguish visual tokens from different transparent foreground layers. The 3D-RoPE application outperforms the absolute layer position encoding method in this regard.

The standard ViT architecture pretrained on the ImageNet classification task employs absolute position encoding, which is inadequate for capturing positional information across a variable number of transparent foreground layers. An additional set of layer-wise absolute position embeddings were used for comparison that provides minimal decoding improvement. On the other hand, replacing the absolute position encoding with the RoPE scheme significantly enhances decoding quality. Among the RoPE schemes, the 3D-RoPE scheme achieves the best alignment between generated layers/images and the ground truth layers/images.

The pipeline applies L1 loss to optimize the parameters of the multilayer transparency decoder 212 while freezing the parameters of the multilayer transparency encoder 250. The multilayer transparency decoder 212 offers advantages including improved efficiency and enhanced transparency predictions, compared to the single-layer transparent decoder.

FIGS. 2E-2G are diagrams of a variation of the AI-based anonymous-region-layout-guided multilayer design generation pipeline of the system of FIG. 1 according to another implementation. The pipeline allows a conditional input scenario, where one or more layers/images are specified by users as input, beside the global text prompt. For example, the layers/images may be generated previously via the pipeline, and the user wants to reuse the layers/images. As another example, the layers/images were just generated by the pipeline, and the user modifies the layers/images, and wants the pipeline to update the output. As yet another example, the layers/images were just retrieved by the user and irrelevant to the pipeline, and the user wants to apply the layers/images with the global text prompt to generate an anonymous-region-layout-guided multilayer graphic design.

The pipeline extends the anonymous region transformer 206 into a conditional anonymous region transformer 207. The conditional anonymous region transformer 207 takes a user text prompt as well as one or more layers/images into modeling and generates other transparent layers to compose into a final design. The conditional anonymous region transformer 207 allows more user input control and support more downstream scenarios.

In FIG. 2E, besides the user text input 222, a user layer/image input 223 (e.g., the background layer 216 and a transparent layer 217, i.e., layer 4) is input to the conditional anonymous region transformer 207. The anonymous region layout planner 204 predicts a conditional anonymous region layout 203. The conditional anonymous region layout 203 includes a background box (i.e., layer 0) and transparent foreground layer anonymous bounding boxes #1-#3 (layers 1-3) in FIG. 2E, given the user text input 222. Then the conditional anonymous region transformer 207 generates the image latents 211 in an embedding space conditioned on the conditional anonymous region layout 203. The anonymous region transformer 206 conditions the reverse diffusion on the anonymous region layout 202, the timestep embeddings 232, the text embeddings 234, and the RoPE positional embeddings 238, while the conditional anonymous region transformer 207 further conditions the reverse diffusion on image embeddings generated form the user layer/image input 223, in order to “guide” the reverse diffusion process. The multilayer transparency decoder 212 concurrently generates a global reference image 214, and three transparent foreground layers 219 from the image latents 211. The pipeline can compose the background layer 216, the input transparent layer, and the three transparent foreground layers 219 into a composed graphic design 221.

FIG. 2F is a diagram of a training process of the conditional anonymous region transformer 207 according to one implementation. The goal of training is to teach the MMDiT 240 how to denoise the masked transparent layers by leveraging the visual information of the visible transparent layers. In one implementation, the training process borrows the multilayer transparency encoder 250 in FIG. 2D to process multilayer training data (e.g., the global reference image 214, the background layer 216, and the four transparent foreground layers 218) into the multilayer image latents z 258. The training process then applies random masking is to select the condition layers and the target prediction layers. For instance, the training process randomly selected image latents of some layers (e.g., the reference image, and layers #1-#3) to mask in step 261 into, i.e., masked multilayer latents 262, and leaving the image latents of the remaining layers (e.g., layers #0, #4) visible, i.e., visible multilayer latents 263. The masked layers (e.g., the reference image, and layers #1-#3) simulate the layers that the user does not provide, allowing the MMDiT 240 to predict these layers during an inference flow. The training process replaces the masked multilayer latents 262 with noise 264

$$( {\{ {ϵ}_{i} \}}_{i = 1}^{K} ∼ 𝒩 ( 0 , {σ}^{2} ) ) ,$$

combines two noise components 266, 267 of the noise 264 with the visible multilayer latents 263 into combined latents 268 in the inference flow. The combined latents 268 are then input to the MMDiT 240 along with the conditional anonymous region layout 203, the timestep embeddings 232, the text embeddings 234, and the RoPE positional embeddings 238, to output masked multilayer direction latents 269.

In step 270, the pipeline improves the MMDiT 240 by modifying the way the model learns to generate data via a smooth trajectory from noise to data, thereby making training more stable and efficient (“rectified flow”).

FIG. 2G is a diagram of the inference flow of the conditional anonymous region transformer 207 according to one implementation. Once trained, the MMDiT 240 can generate new data by reversing the diffusion process on pure noise and user-provided layers/images. The inference flow sequentially transforms/denoises a set of selected pure noisy input 271

$$( e . g . , {\{ {ϵ}_{i} \}}_{i = 1}^{K} ∼ 𝒩 ( 0 , {σ}^{2} ) )$$

into predicted transparent foreground layers via a good layer selection that uses a layer quality assessment model to rate the quality of each generated transparent layer. For example, the layer quality assessment model is a linear estimator on top of CLIP to predict the aesthetic quality of images. There are many alternative models and approaches that have been used for layer quality assessment in image aesthetics, such as neural IMage assessment, random forest/gradient boosting on CLIP features, and the like.

The inference flow selects the most visual appealing layer(s) instead of keeping all of the layers to go to the next round of good layer selection. In FIG. 2G, the MMDiT 240 uses the pure noisy input 271, the conditional anonymous region layout 203, the timestep embeddings 232, the text embeddings 234, and the RoPE positional embeddings 238, to output multilayer latents 272, then goes via a first round 273 of the good layer selection to select the layer #3 as a predicted layer of predicted transparent layers 275. The inference flow then combines image latents of the layer #3 with another noise into a noisy input 274

$$( e . g . , {\{ {ϵ}_{i} \}}_{i = 1}^{K - {l}_{1}} ∼ 𝒩 ( 0 , {σ}^{2} ) ) .$$

Similarly, the MMDiT 240 uses the noisy input 274, the conditional anonymous region layout 203, the timestep embeddings 232, the text embeddings 234, and the RoPE positional embeddings 238, to output multilayer latents 276, then goes via a second round 277 of the good layer selection selects the layers #2, #4 as additional predicted layers 275. The inference flow then combines image latents of the layers #2, #3, #4 with another noise into a noisy input 278

$$( e . g . , {\{ {ϵ}_{i} \}}_{i = 1}^{K - {l}_{1 - {l}_{2}}} ∼ 𝒩 ( 0 , {σ}^{2} ) ) .$$

Again, the MMDiT 240 uses the noisy input 278, the conditional anonymous region layout 203, the timestep embeddings 232, the text embeddings 234, and the RoPE positional embeddings 238, to output multilayer latents 280, then goes via a third round 281 of the good layer selection selects the layers #0, #1 as additional predicted layers 275. As such, the conditional anonymous region transformer 207 generates multiple transparent foreground layer #0-#4, and composes a graphic design (e.g., the composed graphic design 221) accordingly, such as via a layout guided pasting step 283.

Lastly, the inference flow skips the leftmost/initial denoising stage and starts from the second one, i.e., replacing the predicted transparent layers (e.g., the layer #3) in the initial stage with user-provided layers, thereby providing a conditional anonymous region transformation pipeline executed by the conditional anonymous region transformer 207.

The conditional anonymous region layout 203 is applied to the MMDiT 240 in FIGS. 2F-2G in the same way as the anonymous region layout 203 is applied to the MMDiT 240 in FIG. 2C. However, the conditional anonymous region layout 203 is omitted from FIGS. 2F-2G for simplicity. The RoPE positional embeddings 238 is applied to the MMDiT 240 in FIGS. 2F-2G the same way as applied to the MMDiT 240 in FIG. 3C, yet also omitted from FIGS. 2F-2G for simplicity.

Comparing with a full attention scheme and a spatial attention plus temporal attention scheme of the existing approaches, the regional full attention scheme of the anonymous-region-layout-guided multilayer design generation pipeline has better performance (e.g., generated images more closely aligned with real images) due to the anonymous region layout. In addition, the regional full attention scheme of the anonymous-region-layout-guided multilayer design generation pipeline maintains nearly constant computational costs when processing between 10 and 50 layers, whereas the full attention scheme exhibits quadratic growth in memory and inference costs. The full attention scheme does not apply regional cropping and does not use any anonymous region layout. The spatial attention plus temporal attention scheme introduces temporal attention to facilitate interactions across different layers, and does not use any anonymous region layout.

FIGS. 3A-3F are diagrams of an example user interface of an AI-based anonymous-region-layout-guided multilayer design generation application that implements the techniques described herein. The example user interface shown in FIGS. 3A-3F is a user interface of an AI-based anonymous-region-layout-guided multilayer design generation application within an AI-based design platform, such as but not limited to Microsoft Designer®. However, the techniques herein for AI-based anonymous-region-layout-guided multilayer design generation are not limited to use in an AI-based design platform and may be used to generate graphic designs for other types of applications including but not limited to presentation applications, website authoring applications, collaboration platforms, communications platforms, and/or other types of applications in which users create, view, and/or edit various graphic designs based on a text prompt. Such applications can be a mini application in an AI-based design application, a stand-alone application, or a plug-in of any application on the client device 105, such as the browser application 112, the native application 114, and the like. For example, the system can work on the web or within a virtual meeting and collaboration application (e.g., Microsoft Teams®) or an email application (e.g., Outlook®). The system can be integrated into the Microsoft Viva® platform or could work within a browser (e.g., Windows® Edge®). The system can also work within a social media website/application (e.g., Facebook®, Instagram®).

FIG. 3A shows an example of the user interface 305 of an AI-based anonymous-region-layout-guided multilayer design generation application (e.g., Microsoft Designer®) in which the user is interacting with AI generative model(s) to generate different types of images, graphic designs, and the like based on various inputs. The user interface 305 includes a control pane 315, a chat pane 325 and a scrollbar 335. The user interface 305 may be implemented by the native application 114 and/or the browser application 112.

In some implementations, the control pane 315 includes an Assistant button 315a, a Generate button 315b, a Share button 315c, an Edit button 315d, and a search field 315e. The AI-Assistant button 315a can be selected to provide anonymous-region-layout-guided multilayer graphic design functions as discussed. In some implementations, the chat pane 325 provides a workspace in which the user can enter prompts in the AI-based anonymous-region-layout-guided multilayer design generation application for generating anonymous-region-layout-guided multilayer graphic designs. In the example shown in FIG. 3A, the chat pane 325 shows at least two mini application tiles 325a and 325b.

The mini application tile 325a represents an image creator and depicts a description of “Create any image you can image—just enter in a text description.” The mini application tile 325a also depicts a prompt enter box over a sample imagine and a “Generate” button. The prompt enter box already shows an sample prompt of “a city with buildings made of colorful candies” over the sample image created by the image creator based on the sample prompt. A user can enter a new prompt in the prompt enter box and then select the ‘Generate’ button to create a new image.

The mini application tile 325b represents a graphic design generator and depicts a description of “Text to design!” The mini application tile 325b also depicts a “Try it!” button. The prompt enter box shows an instruction of “Create any design you can image—just enter in a text description.”

When the user selects the Generate button 315b, a dropdown list of mini applications is displayed for the user to select. The user can select the graphic design generator to generate anonymous-region-layout-guided multilayer graphic designs, by entering a user text input 222 to generate a sale poster. The Share button 315c can be selected to trigger the dropdown list of the mini applications to share the generated content, such as the generated anonymous-region-layout-guided multilayer graphic designs. The Edit button 315d can be selected to edit the generated anonymous-region-layout-guided multilayer graphic designs. The search field 315e is for a user to enter a search word, phrase, paragraph, and the like within the visual content library 142, the requests, prompts, and responses 144, the extracted/inferred user data 146 (e.g., user preferences), the training data 148, and the like. The fields in the AI-based anonymous-region-layout-guided multilayer design generation application can provide auto-fill and/or spell-check functions.

The pipeline enables layer-wise image editing, including accurately regenerating contents on specific layers. The layer-wise editing consists of three steps: modifying the input prompt, re-generating the layers that need to be edited, and freezing the remaining layers as shown in FIGS. 3B-3E. The pipeline can accurately regenerate specific content on the editable layers to meet the requirements from the input prompt. Moreover, the newly generated layer remains harmonious with the rest while keeping other layers unchanged, providing a feasible approach to precisely and independently control the style and contents of each layer

FIG. 3B continues from FIG. 3A upon a selection of the mini application tile 325b by, for example, hovering a cursor over the mini application tile 325b, and/or clicking on any pixel in the mini application tile 325b. In this example, the chat pane 325 shows a prompt enter box 325c with instructions of ‘a promotional Easter-themed graphic featuring a large, colorful egg with text “AFFORDABLE EASTER” at the top. It includes discount badges stating “50% OFF” and “ORDER TODAY” on either side of the egg, with the tagline “Essentials Without Breaking the Bank” at the bottom’ entered by the user. Upon a user selection of the Generate button 315b, an anonymous-region-layout-guided multilayer graphic design 345a is output based on the above-discussed implementations, with eleven transparent foreground layers shown on the side. The eleven layers include a white background layer, six visual object layers, and four text layers. The chat pane 325 shows an arrow 345b for the user to select a layer for manipulation, a field 325d with an instruction of “Enter new description for the selected layer,” and a field 325e with an instruction of “Explore another graphic object for the selected layer.” When the user moved the arrow 345b over one of a layer 345c of text “order today”, the field 325d with the instruction of “Enter new description for the selected layer” get highlighted. The user can freely edit the multilayer graphic design 345a per layer as in the discussed implementations.

In FIG. 3C, the user enters another text prompt in the box 325c “A promotional Easter-themed graphic featuring a large, colorful egg with text “AFFORDABLE EASTER” at the top. It includes discount badges stating “50% OFF” and “ORDER TODAY” on either side of the egg, with the tagline “Essentials Without Breaking the Bank“at the bottom.” The pipeline generates another multilayer graphic design 345d in the chat pane 325. In this case, FIG. 3C shows an anonymous region layout 345e of the multilayer graphic design 345d, instead of any transparent foreground layers.

In FIG. 3D, the user enters an instruction in a box 325f to manipulate the multilayer graphic design 345d across layers, instead of moving an arrow to edit per layer as in FIG. 3C. The instruction in the box 325f “the three cookies are in magenta, cyan, and orange colors, respectively” changes the multilayer graphic design 345d into a multilayer graphic design 345f with the cookies in magenta, cyan, and orange colors. FIG. 3D also shows an anonymous region layout 345g of the multilayer graphic design 345f. In particular, the regions/layers #3, #5, #6 correspond to the three cookies were highlighted since they were just modified.

In FIG. 3E, the user enters another instruction in the box 325f “Change the text from “sansserif font” to “swash style font””, to manipulate the text in the multilayer graphic design 345d across layers. The multilayer graphic design 345d is changed into a multilayer graphic design 345h with text element “WINTER SEASON SPECIAL COOKIES” of a different font. FIG. 3E also shows an anonymous region layout 345i of the multilayer graphic design 345h. In particular, the regions/layers #4, #7 correspond to the text items were highlighted since their font was just modified.

In FIG. 3F, beside a global text prompt, the user drops three transparent layers 345j in the box 325f that shows “Drag & Drop your own transparent layers to add to the design” as default, to generate another design. First, the pipeline uses the following global text prompt to generate a conditional anonymous region layout: “the image features a woman with a radiant smile, who appears to be in a state of relaxation or enjoyment. She is wearing a white towel wrapped around her head, suggesting she might be in a spa or beauty center setting. Her hands are gently placed on her cheeks, and she is holding a small, circular object, possibly a facial mask or a skincare product, near her face. The background is a soft, pastel pink, which adds to the serene and calming atmosphere of the image. At the bottom of the image, there is text that reads “Beauty & Spa Center” in a cursive, elegant font, indicating that the image is likely an advertisement or promotional material for a beauty and spa establishment. Below this text, there is a call to action that says “BOOK NOW” in a bold, sans-serif font, suggesting that the viewer can book an appointment or service at the center. The overall style of the image is clean, modern, and inviting, designed to attract potential customers to the beauty and spa center.”

The pipeline then applies the conditional anonymous region layout and the three transparent layers 345j to generate a multilayer graphic design 345k. The multilayer graphic design 345k thus generates additional four transparent layers 345l, and incorporates the three transparent layers 345j with the four transparent layers 345l into the multilayer graphic design 345k. In this case, the multilayer graphic design 345k is a spa center flyer that incorporates a text overlay layer, two text layers of “BOOK NOW,” and “Beauty & Spa Center,” as well as four image object layers.

In one embodiment, the multilayer transparent graphic design outputs are saved in the visual content library 142 in case the same user wants to use the same multilayer transparent graphic design outputs. The extracted/inferred user data 146 (e.g., user preferences) is tentatively linked with a user ID during a user session and saved in a cache. After the user session, extracted/inferred user data 146 is de-linked form the user ID as metadata of the multilayer transparent graphic design output and saved in the visual content library 142. In addition, the extracted/inferred user data 146 linked with the user ID is saved back to the user database 128.

The AI model(s) 126 may be included as part of the application services platform 110 or they may be external models that are called by the application services platform 110. In implementations where other models in addition to the AI model(s) 126 are utilized, those models may be included as part of the application services platform 110 or they may be external models that are called by the application services platform 110.

The request processing unit 122 also coordinates communication and exchange of data among components of the application services platform 110 as discussed in the examples which follow. The request processing unit 122 receives a user request to generate a graphic design with desired style(s) from the native application 114 or the browser application 112.

In some implementations, the application services platform 110 complies with privacy guidelines and regulations that apply to the usage of the user data included in the user database 128 to ensure that users have control over how the application services platform 110 utilizes their data. The user is provided with an opportunity to opt into the application services platform 110 to allow the application services platform 110 to access the user data and enable the AI model(s) 126 to generate graphic designs according to the user's desired style/objects.

The enterprise data storage 140 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

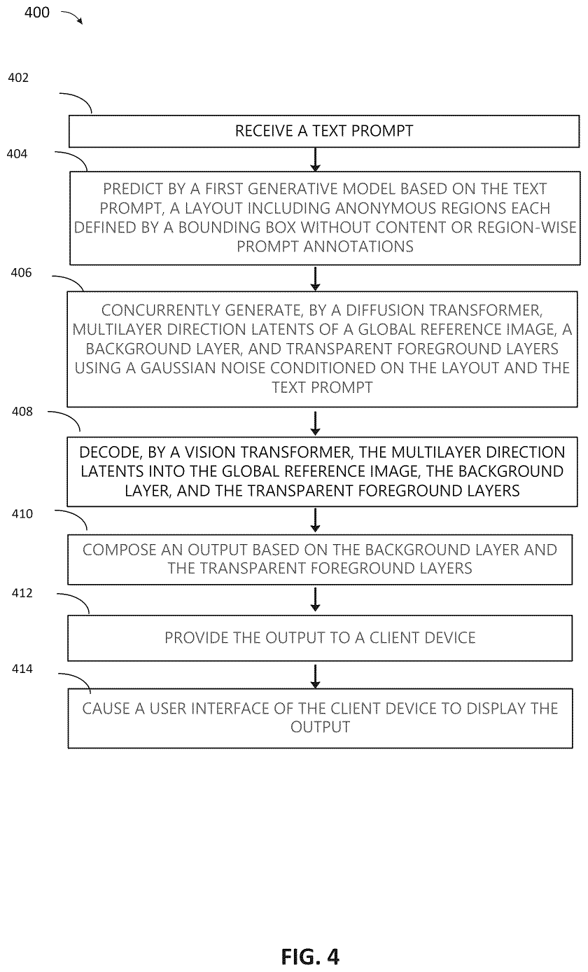

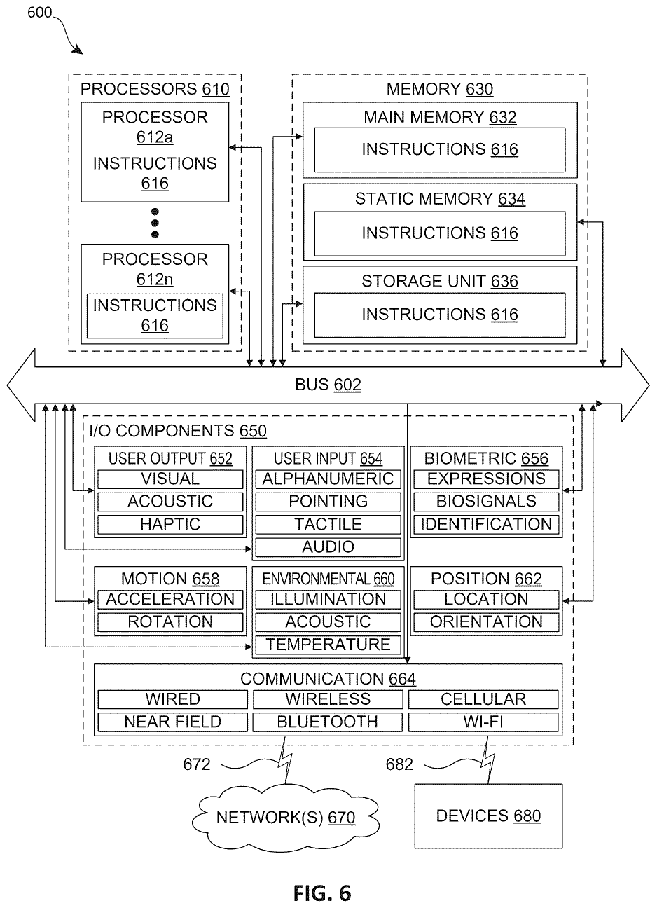

FIG. 4 is a flow chart of an example process 400 for AI-based anonymous-region-layout-guided multilayer design generation according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one implementation, for example, in step 402, a request processing unit (e.g., the request processing unit 122) receives a text prompt (e.g., the user text input 222 in FIG. 2A) to create a multilayer graphic design (e.g., the composed graphic design 220 in FIG. 2A).

In step 404, a first generative model (e.g., the LLM 126a) predicts based on the text prompt, a layout (e.g., the anonymous region layout 202 in FIGS. 2A-2B) including a plurality of anonymous regions each defined by a bounding box (e.g., the bounding boxes #0-#4 in FIG. 2A, the bounding boxes #0-#3 in FIG. 2B, and the like) without content or region-wise prompt annotations (e.g., “A stark top-down view of a white dessert plate” in FIG. 2B).

In step 406, a diffusion transformer (e.g., the diffusion model 126b, the multimodal diffusion transformer (MMDiT) 240 in FIG. 2C, and the like) concurrently generates multilayer image latents (e.g., the multilayer image latents 210) of a global reference image (e.g., the global reference image 214), a background layer (e.g., the background layer 216), and a plurality of transparent foreground layers (e.g., the transparent foreground layers 218) using a Gaussian noise conditioned on the layout and the text prompt. Each of the transparent foreground layers corresponding to one of the anonymous regions. In addition, an anonymous region transformer 206 encodes relative position information associated with the multilayer image latents based on the layout as multilayer rotary position embeddings (e.g., 3D RoPE embedding 238). The multilayer image latents are generated with the multilayer rotary position embeddings.

Moreover, the anonymous region transformer 206 generates timestep embeddings (e.g., the timestep embeddings 232), and provides the timestep embeddings 232 to the diffusion transformer as temporal context when generating the multilayer image latents 210. Furthermore, the anonymous region transformer 206 generates text embeddings (e.g., the text embeddings 234) based on the text prompt, and provides the text embeddings 234 to the diffusion transformer as text tokens for generating the multilayer image latents 210.

In step 408, a vision transformer (e.g., the vision transformers (ViT) 244) decodes the multilayer image latents (e.g., the multilayer image latents 210) into the global reference image, the background layer, and the plurality of transparent foreground layers as the multilayer graphic design. In step 410, an output is composed (e.g., by the request processing unit 122) based on the background layer and the plurality of transparent foreground layers.

In step 412, the request processing unit 122 provides the output to a client device (e.g., the client device 105). In step 414, the request processing unit 122 causes a user interface (e.g., the user interface 305) of the client device to display the output. In another implementation, the request processing unit 122 provides the plurality of transparent foreground layers to the client device, and causes the user interface of the client device to display the plurality of transparent foreground layers. For example, each of the plurality of transparent foreground layers are displayed in a two-dimensional matrix of identical-sized boxes with respective design elements (e.g., the matrix next to the graphic design 345a in FIG. 3B), or displayed as bounding boxes of various sizes without design elements based on the layout (e.g., the bounding boxes in the anonymous region layout 345e in FIG. 3C). After receiving one or more user edits to at least one of the plurality of transparent foreground layers, a second output is composed based on the plurality of transparent foreground layers including the one or more user edits, and the request processing unit 122 causes the user interface of the client device to display the second output.

The multilayer transparent autoencoder 208 (in FIG. 2D) retrieves training data including a training layout (e.g., the anonymous region layout 202), a training global reference image (e.g., the global reference image 214), a training background layer (e.g., the background layer 216), and a plurality of training transparent foreground layers (e.g., the transparent foreground layers 218), converts the training background layer into a gray background layer, and converts the plurality of training transparent foreground layers into a plurality of training foreground layers padded with a gray-background. A variational autoencoder (VAE) encoder (e.g., the VAE encoder 252) of the multilayer transparent autoencoder 208 jointly generates multilayer image latents (e.g., the blocks of multilayer image tokens 254) of the training global reference image, the gray background layer, and the plurality of training foreground layers. The multilayer transparent autoencoder 208 applies a ceiling-aligned tight crop on the image latents of each of the plurality of training foreground layers, flattens and concatenates the image latents of the training global reference image, the training background layer, and the cropped image latents of the plurality of training foreground layers, into one sequence of image latents (e.g., the multilayer image latents z 258), and feeds the sequence of image latents into a pre-trained vision transformer to be trained into the vision transformer (e.g., the ViT 244). In addition, the multilayer transparent autoencoder 208 encodes relative position information associated with the multilayer image latents (e.g., the multilayer image latents z 258) based on the layout as multilayer rotary position embeddings (e.g., the 3D RoPE embedding 246). The multilayer image latents (e.g.,) are generated with the multilayer rotary position embeddings 246.

The pipeline starts with planning an anonymous region layout that is sufficient for the multilayer transparent image generation task. The pipeline then applies the anonymous region transformer to generate multilayer transparent images from the anonymous region layout. The anonymous region transformer can adaptively assigns semantic concepts to fit diverse anonymous region layouts. The pipeline offers several key advantages over traditional semantic layout methods, including better coherence across layers and more scalable annotation. In addition, the pipeline efficiently generates images with numerous distinct transparent foreground layers, thereby reducing computational costs while generalizing to various distinct anonymous region layouts. Furthermore, the pipeline supports the generation of tens of high-quality transparent foreground layers from a global prompt and a dense anonymous region layout. In contrast, the existing approaches are limited to generating only a small number of layers.

The system allows users to generated unlimited numbers of transparent layers thus adding user control to the graphic design process. This ease of use increases user productivity and utilization, as well as attracts more non-technical users who are not trained to enter complicated text prompts. This solution significantly lowers the barrier to create high-quality, stylized layouts, and makes the consistent artistic graphic design creation process more efficient and open.

Besides, the system also integrates the generated elements harmoniously, reducing the semantic gap that often plagues conventional methods. This results in more consistent and visually appealing designs

In some implementations, the system can apply/share the anonymous-region-layout-guided graphic designs immediately, so that the user can celebrate the relevant event (e.g., the user's birthday). Moreover, the anonymous-region-layout-guided graphic design approach can be a fun and creative way for individuals to add a personal touch to their invitations, cards, personal profiles, and other graphic designs that show and consider all design elements given by a user.

Therefore, the system provides an anonymous-region-layout-guided multilayer graphic design based on a text prompt. The system personalizes the comprehensive multilayer transparent graphic design outputs for the user. In addition, the system can modify the anonymous-region-layout-guided multilayer graphic design outputs editable at a layer level.

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the hardware modules described may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

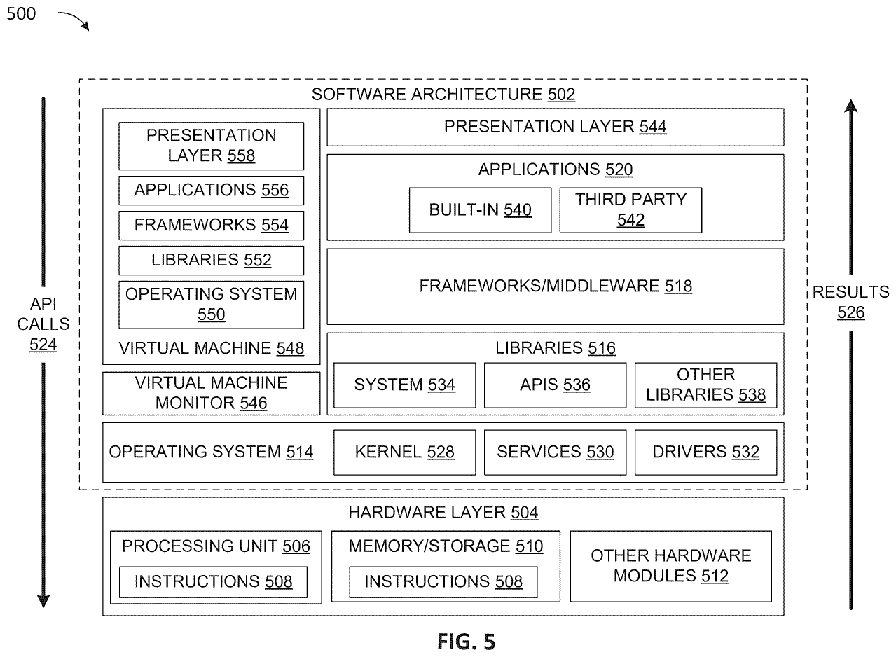

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, and file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform operations:
receiving a text prompt to create a multilayer graphic design;
predicting, by a first generative model based on the text prompt, a layout including a plurality of anonymous regions each defined by a bounding box without content or region-wise prompt annotations;
concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions;
decoding, by a vision transformer, the multilayer image latents into the global reference image, the background layer, and the plurality of transparent foreground layers as the multilayer graphic design;
composing an output based on the background layer and the plurality of transparent foreground layers;
providing the output to a client device; and
causing a user interface of the client device to display the output.

2. The data processing system of claim 1, wherein the machine-readable storage medium further includes instructions configured to cause the processor alone or in combination with other processors to perform operations of:
encoding relative position information associated with the multilayer image latents based on the layout as multilayer rotary position embeddings,
wherein the multilayer image latents are generated with the multilayer rotary position embeddings.

3. The data processing system of claim 1, wherein the machine-readable storage medium further includes instructions configured to cause the processor alone or in combination with other processors to perform operations of:
generating timestep embeddings; and
providing the timestep embeddings to the diffusion transformer as temporal context when generating the multilayer image latents.

4. The data processing system of claim 1, wherein the machine-readable storage medium further includes instructions configured to cause the processor alone or in combination with other processors to perform operations of:
generating text embeddings based on the text prompt; and
providing the text embeddings to the diffusion transformer as text tokens for generating the multilayer image latents.

5. The data processing system of claim 1, wherein the machine-readable storage medium further includes instructions configured to cause the processor alone or in combination with other processors to perform operations of:
retrieving training data including a training layout, a training global reference image, a training background layer, and a plurality of training transparent foreground layers;
converting the training background layer into a gray background layer;
converting the plurality of training transparent foreground layers into a plurality of training foreground layers padded with a gray-background;
jointly generating, by a variational autoencoder (VAE) encoder, multilayer image latents of the training global reference image, the gray background layer, and the plurality of training foreground layers;
applying a ceiling-aligned tight crop on the image latents of each of the plurality of training foreground layers;
flattening and concatenating the image latents of the training global reference image, the training background layer, and the cropped image latents of the plurality of training foreground layers, into one sequence of image latents; and
feeding the sequence of image latents into a pre-trained vision transformer to be trained into the vision transformer.

6. The data processing system of claim 5, wherein the machine-readable storage medium further includes instructions configured to cause the processor alone or in combination with other processors to perform operations of:
encoding relative position information associated with the multilayer image latents based on the layout as multilayer rotary position embeddings, wherein the multilayer image latents are generated with the multilayer rotary position embeddings.

7. The data processing system of claim 1, wherein the machine-readable storage medium further includes instructions configured to cause the processor alone or in combination with other processors to perform operations of:
providing the plurality of transparent foreground layers to the client device; and
causing the user interface of the client device to display the plurality of transparent foreground layers.

8. The data processing system of claim 7, wherein each of the plurality of transparent foreground layers are displayed in a two-dimensional matrix of identical-sized boxes with respective design elements, or displayed as bounding boxes of various sizes without design elements based on the layout.

9. The data processing system of claim 7, wherein the machine-readable storage medium further includes instructions configured to cause the processor alone or in combination with other processors to perform operations of:
receiving one or more user edits to at least one of the plurality of transparent foreground layers;
composing a second output based on the plurality of transparent foreground layers including the one or more user edits; and
causing the user interface of the client device to display the second output.

10. The data processing system of claim 1, wherein the first generative model is a large language model, and the diffusion transformer is a multimodal diffusion transformer.

11. A method comprising:
receiving a text prompt to create a multilayer graphic design;
predicting, by a first generative model based on the text prompt, a layout including a plurality of anonymous regions each defined by a bounding box without content or region-wise prompt annotations;
concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions;
decoding, by a vision transformer, the multilayer image latents into the global reference image, the background layer, and the plurality of transparent foreground layers as the multilayer graphic design;
composing an output based on the background layer and the plurality of transparent foreground layers;
providing the output to a client device; and
causing a user interface of the client device to display the output.

12. The method of claim 11, further comprising:
encoding relative position information associated with the multilayer image latents based on the layout as multilayer rotary position embeddings,
wherein the multilayer image latents are generated with the multilayer rotary position embeddings.

13. The method of claim 11, further comprising:
generating timestep embeddings; and
providing the timestep embeddings to the diffusion transformer as temporal context when generating the multilayer image latents.

14. The method of claim 11, further comprising:
generating text embeddings based on the text prompt; and
providing the text embeddings to the diffusion transformer as text tokens for generating the multilayer image latents.

15. The method of claim 11, further comprising:
retrieving training data including a training layout, a training global reference image, a training background layer, and a plurality of training transparent foreground layers;
converting the training background layer into a gray background layer;
converting the plurality of training transparent foreground layers into a plurality of training foreground layers padded with a gray-background;
jointly generating, by a variational autoencoder (VAE) encoder, multilayer image latents of the training global reference image, the gray background layer, and the plurality of training foreground layers based on Gaussian noise conditioned on the training layout;
applying a ceiling-aligned tight crop on the image latents of each of the plurality of training foreground layers;
flattening and concatenating the image latents of the training global reference image, the training background layer, and the cropped image latents of the plurality of training foreground layers, into one sequence of image tokens; and
feeding the sequence of image tokens into a pre-trained vision transformer to be trained into the vision transformer.

16. A non-transitory computer readable medium on which are stored instructions that, when executed, cause a programmable device to perform functions of:
receiving a text prompt to create a multilayer graphic design;
predicting, by a first generative model based on the text prompt, a layout including a plurality of anonymous regions each defined by a bounding box without content or region-wise prompt annotations;
concurrently generating, by a diffusion transformer, multilayer image latents of a global reference image, a background layer, and a plurality of transparent foreground layers using a Gaussian noise conditioned on the layout and the text prompt, each of the transparent foreground layers corresponding to one of the anonymous regions;
decoding, by a vision transformer, the multilayer image latents into the global reference image, the background layer, and the plurality of transparent foreground layers as the multilayer graphic design;
composing an output based on the background layer and the plurality of transparent foreground layers;
providing the output to a client device; and
causing a user interface of the client device to display the output.

17. The non-transitory computer readable medium of claim 16, wherein the instructions when executed, further cause the programmable device to perform:
encoding relative position information associated with the multilayer image latents based on the layout as multilayer rotary position embeddings,
wherein the multilayer image latents are generated with the multilayer rotary position embeddings.

18. The non-transitory computer readable medium of claim 16, wherein the instructions when executed, further cause the programmable device to perform:
generating timestep embeddings; and
providing the timestep embeddings to the diffusion transformer as temporal context when generating the multilayer image latents.

19. The non-transitory computer readable medium of claim 16, wherein the instructions when executed, further cause the programmable device to perform:
generating text embeddings based on the text prompt; and
providing the text embeddings to the diffusion transformer as text tokens for generating the multilayer image latents.

20. The non-transitory computer readable medium of claim 16, wherein the instructions when executed, further cause the programmable device to perform:
retrieving training data including a training layout, a training global reference image, a training background layer, and a plurality of training transparent foreground layers;
converting the training background layer into a gray background layer;
converting the plurality of training transparent foreground layers into a plurality of training foreground layers padded with a gray-background;
jointly generating, by a variational autoencoder (VAE) encoder, multilayer image latents of the training global reference image, the gray background layer, and the plurality of training foreground layers based on Gaussian noise conditioned on the training layout;
applying a ceiling-aligned tight crop on the image latents of each of the plurality of training foreground layers;
flattening and concatenating the image latents of the training global reference image, the training background layer, and the cropped image latents of the plurality of training foreground layers, into one sequence of image tokens; and
feeding the sequence of image tokens into a pre-trained vision transformer to be trained into the vision transformer.
